(19) United States
(12) Patent Application Publication
(10) Pub. No.: US 2017/0003916 A1
(43) Pub. Date: Jan. 5, 2017

(54) CONTROL METHOD OF A PRINTER, PRINTER, AND STORAGE MEDIUM

(71) Applicant: Seiko Epson Corporation, Tokyo (JP)

(72) Inventors: Makoto NOGUCHI, (US); Akio TAKAMOTO, Shiojiri-shi (JP); Makoto YOSHIKI, Matsumoto-shi (JP); Masahiro TAKEI, Shiojiri-shi (JP)

(73) Assignee: Seiko Epson Corporation, Tokyo (JP)

(21) Appl. No.: 15/193,998

(22) Filed: Jun. 27, 2016

(30) Foreign Application Priority Data
Jul. 2, 2015 (JP) 2015-133372

(51) Int. Cl. G06F 3/12; G06K 15/00; G06K 15/02; G06F 9/48

(52) U.S. Cl. CPC G06F 3/123; G06F 9/4881; G06K 15/408; G06K 15/1817; G06K 15/1805; G06F 3/1234; G06F 3/1294; G06F 3/1296

(57) ABSTRACT

A device control program can be updated even when the printing device is busy. A control method of a printer 2 having a storage unit 32 storing a device control program 36 and a boot program 37, and a communication interface 21 that communicates with a host device 1, includes: a receive change-mode request step of receiving a change-mode request from the host device 1 through the communication interface 21; a change mode step of changing from a normal control mode in which the device control program 36 runs to a boot control mode in which the boot program 37 runs based on the change-mode request; the communication interface 21 receiving a change-mode request in the receive change-mode request step even if the communication interface 21 reports being busy.

This application claims priority under 35 U.S.C. §119 to Japanese Patent Application No. 2015-133372 filed on Jul. 2, 2015, the entire disclosure of which is expressly incorporated by reference herein.

### BACKGROUND

1. Technical Field

The present disclosure relates to a control method of a printer, a printer, and a storage medium.

2. Related Art

Program upgrade systems (program management system) including a management device (program management device) and a printing device (printer) are known from the literature. See, for example, JP-A-2010-198630. In such a program upgrade system, the management device sends update data (a control program for upgrading or firmware for upgrading) to the printer, and the printer then executes a process to update the device control program (control program or firmware) based on the update data.

When the printer is unable to print for some reason or an error occurs, however, the printer may be busy and unable to communicate at times. A problem with the program upgrade system according to the related art described above is that when the printer is busy, communication is not possible, and the printer cannot receive the update data from the management device and update the control program.

### SUMMARY

A printer control method and a printer according to the disclosure enable updating the control program even when the printing device is busy.

A control method of a printing device capable of communicating with a management device according to at least one embodiment of the invention includes steps of: storing a control program configured to control printing, and a boot program configured to update the control program; and even when a busy state is reported to the management device, receiving a change-mode request from the management device, and based on the change-mode request, changing from a normal control mode configured to execute the control program to a boot control mode configured to execute the boot program.

A printing device according to another aspect of the invention has: a storage (storage unit) configured to store a control program configured to control printing, and a boot program configured to update the control program; a communicator (communication unit) configured to communicate with a management device; and a controller (control unit) configured to execute the control program and the boot program. The communicator receives a change-mode request from the management device even when a busy state is reported to the management device; and the controller changes from a normal control mode configured to execute the control program to a boot control mode configured to execute the boot program, based on the change-mode request.

Further preferably, a control method of a printing device according to another aspect of the invention also includes receiving update data even when a busy state is reported to the management device, and updating the control program to the update data by the boot program, in the boot control mode.

Further preferably in a printing device according to another aspect of the invention, the communicator receives update data even when a busy state is reported to the management device, and the controller updates the control program to the update data by the boot program, in the boot control mode.

In the control method of a printing device according to another aspect of the invention, the busy state is reported to the management device when an error occurs, when waiting for recovery from an error, and when printing is not possible.

In a printing device according to another aspect of the invention, the communicator reports a busy state to the management device when an error occurs, when waiting for recovery from an error, and when printing is not possible.

Thus comprised, the printer can receive change-mode requests and change to the boot control mode even when the printer is unable to receive normal communications (that is, when the printer is in a busy state, including error states, waiting to be reset from an error, and being unable to print) and reports being busy to the management device. The control program can therefore be updated by update data received from the management device even when the printing device is busy. For example, if the printing device reports being busy because, for example, a cover that must be opened to load print media is open (a cover-open state), the paper has run out, or other event preventing printing occurs, change-mode requests and commands and data required for updating can still be received, and the control program can be updated.

The control method of a printing device according to another aspect of the invention further includes changing from the normal control mode to the boot control mode with priority over other processes when the change-mode request is received.

In a printing device according to another aspect of the invention, the controller executes a change-mode request with priority over other processes.

Thus comprised, processing change-mode requests can be prioritized, enabling quick updates. For example, even if another command is already stored in the receive buffer described below, executing change-mode requests can be prioritized for immediate updating.

In a control method of a printing device according to another aspect of the invention, the printing device has a receive buffer configured to store data received from the management device, and when the change-mode request is received, clears data in the receive buffer.

Because this aspect of the invention deletes (clears) data from the receive buffer, problems such as data being processed mistakenly in the boot control mode because data is left in the receive buffer, and data remaining in the receive buffer being mistakenly stored as part of the update data, can be eliminated. For example, data remaining in the receive buffer being sent to the management device instead of the data that is actually required can be avoided. The printer can also be triggered to automatically delete data in the receive buffer by receiving a change-mode request from the management device. As a result, there is no need for the management device to send a command to delete data in the receive buffer, and processing can be simplified.

In a control method of a printing device according to another aspect of the invention, normal commands that are processed in the order received, and real-time commands that are processed with priority over normal commands, can be executed in the normal control mode; and real-time commands can be executed in the boot control mode.

In a printing device according to another aspect of the invention, the controller processes normal commands that are processed in the order received, and real-time commands that are processed with priority over normal commands, in the normal control mode; and can execute real-time commands in the boot control mode.

This aspect of the invention can restrict the commands that are received by the printing device, including commands containing the update data, to real-time commands when in the boot control mode. As a result, command interpretation in the boot control mode can be simplified. The boot program can therefore be simplified, and occupies less space in the storage. Processing in the boot control mode can also be simplified.

A control method of a printing device according to another aspect of the invention preferably receives an information request requesting information of the printing device from the management device even when a busy state is reported to the management device; and based on the information request, sends the information of the printing device to the management device.

In a printing device according to another aspect of the invention, the communicator preferably receives an information request requesting information of the printing device from the management device even when a busy state is reported to the management device, and sends the information of the printing device to the management device based on the information request.

Thus comprised, because the management device generates and sends update data based on the acquired printer information, the printing device can receive and update data matching the printing device. Receiving and processing update data are also possible while the printing device is busy.

A control method of a printing device according to another aspect of the invention preferably also includes: receiving a response request for confirming whether or not the boot control mode was enabled from the management device; sending response confirmation information indicating whether or not the boot control mode was enabled; and if response confirmation information indicating the boot control mode was not enabled is sent, receiving update data in a specific defined data format from the management device, and updating the control program to the update data.

Further preferably in a printing device according to another aspect of the invention, the communicator receives a response request for confirming whether or not the boot control mode was enabled from the management device, sends response confirmation information indicating whether or not the boot control mode was enabled, and if response confirmation information indicating the boot control mode was not enabled is sent, receives update data in a defined data format from the management device; and the controller updates the control program to the update data.

Thus comprised, response confirmation information indicating the boot control mode is not enabled is sent from the printing device, and when the management device cannot acquire the printer information, sends update data to the printing device in a data format specific to the storage of the printing device (such as a data format based on the sectors (sector units) of flash ROM enabling writing direct to memory). As a result, the update process being cancelled can be avoided by converting the data format of the transmitted update data when the printer information cannot be acquired.

Other objects and attainments together with a fuller understanding of the invention will become apparent and appreciated by referring to the following description and claims taken in conjunction with the accompanying drawings.

### BRIEF DESCRIPTION OF THE DRAWINGS

FIG. 1 illustrates the configuration of a printing system according to the disclosure.

FIG. 2 is a function block diagram illustrating the functional configuration of a host device and printer.

FIG. 3 shows an example of the content of update units in the update data file.

FIG. 4 is used to describe the update data selection process.

FIG. 5 is a flow chart showing steps in the first part of the device control program in the printing system according to the disclosure.

FIG. 6 is a flow chart showing steps in the second part of the device control program in the printing system according to the disclosure.

### DESCRIPTION OF EMBODIMENTS

Preferred embodiments of a control method of a printing device and a printing device (printer) according to the present disclosure are described below with reference to the accompanying figures. The following embodiment uses a printing system as an exemplary application of the disclosure. This printing system executes a printing process on a print medium, and produces a printout. This printing system functions as a program upgrade system for updating device control programs on plural models of printers with different function modules.

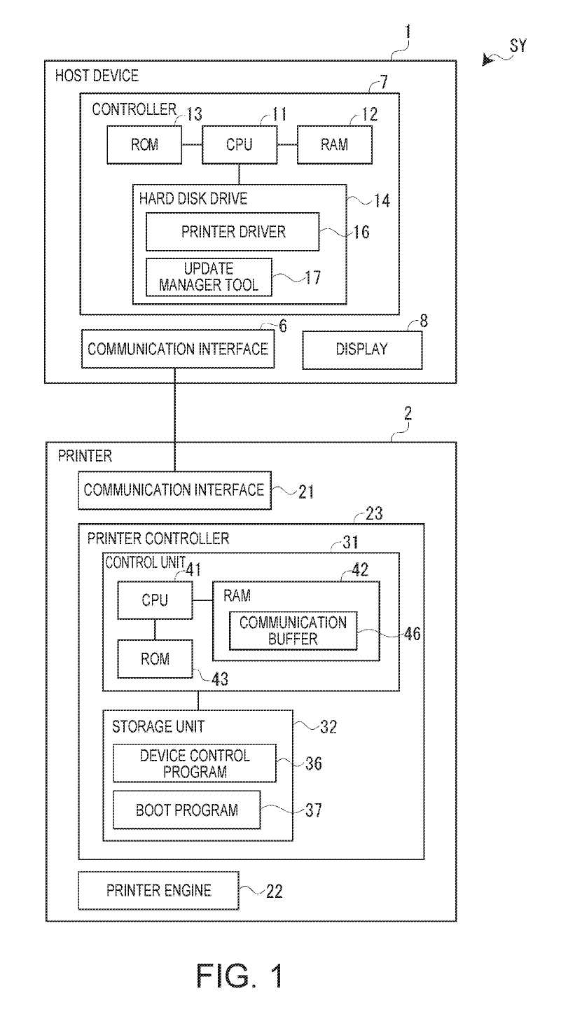

As shown in FIG. 1, the printing system SY includes a host device 1 (management device) and a printer 2 connected to the host device 1. The host device 1 and printer 2 may be configured to communicate by wire or wirelessly. The host device 1 and printer 2 may also be configured to connect directly or through a network (Internet or local area network).

The host device 1 generates commands and sends the generated commands to the printer 2, and has a communication interface 6 for exchanging data with the printer 2, and a controller 7 that controls the communication interface 6. The host device 1 also has a display 8 for displaying information.

The communication interface 6 communicates data with the printer 2. More specifically, the communication interface 6 sends data including the foregoing commands to the printer 2, and receives data from the printer 2.

The controller 7 has a CPU 11 (central processing unit), RAM 12 (random access memory), ROM 13 (read only memory), and a hard disk drive 14, and centrally controls the host device 1. The hard disk drive 14 stores a printer driver 16 and an update manager tool 17. By the controller 7 running the update manager tool 17, the host device 1 functions as a management device that manages executing update processes by the printer 2.

The printer 2 receives commands from the host device 1, and executes processes based on those commands. For example, the printer 2 applies a printing process to a print medium based on print commands. There are plural different models of printers 2 with different function modules, such as a model with a Bluetooth® module and a model with a network module. In other words, a printer 2 in this example is selectively configured with one or more modules selected from among plural different modules.

The printer 2 also has a communication interface 21 (communicator) for exchanging data with the host device 1; a printer engine 22 that applies a printing process to print media; and a printer controller 23 that controls the communication interface 21 and printer engine 22. The printer 2 receives commands through the communication interface 21 as controlled by the printer controller 23. If the received command is a print command, the printer engine 22 executes a printing process on the recording medium based on the print commands. As a result, a printout is produced.

The communication interface 21 communicates with the host device 1. More specifically, the communication interface 21 receives data including commands from the host device 1 and sends data to the host device 1.

The printer controller 23 includes a control unit (controller) 31 that centrally controls the printer 2, and a storage unit (storage) 32 that stores data. The storage unit 32 in this example is rewritable flash ROM, and nonvolatilely stores a device control program 36 for controlling parts of the printer 2, and a boot program 37 for updating the device control program 36. Included in the device control program 36 are firmware and configuration setting for the modules of the printer 2.

The control unit 31 has CPU 41, RAM 42, and ROM 43, and centrally controls the printer 2. A communication buffer 46 (receive buffer) is reserved in RAM 42. The communication buffer 46 temporarily stores data received by the communication interface 21 from the host device 1, and data that is sent to the host device 1 by the communication interface 21. The communication buffer 46 in this example is a FIFO (First In First Out) buffer.

The printer 2 in this embodiment of the invention executes normal processes including the printing process by the control unit 31 running the device control program 36, and executes an update process to update the device control program 36 by the control unit 31 running the boot program 37. The printer 2 therefore has a normal control mode in which the control unit 31 executes the device control program 36, and a boot control mode in which the control unit 31 executes the boot program 37, and to execute the device control program 36 update process, switches from the normal control mode to the boot control mode and executes the update process. Note that both normal command and real-time commands can be executed in the normal control mode, and only real-time commands can be executed in the boot control mode. Normal commands are commands that are processed in the order they are stored by the printer 2 in the communication buffer 46 (the order received by the communication interface 21). Real-time commands are commands the printer 2 processes with priority over normal commands, and commands the printer 2 executes with priority over other processes.

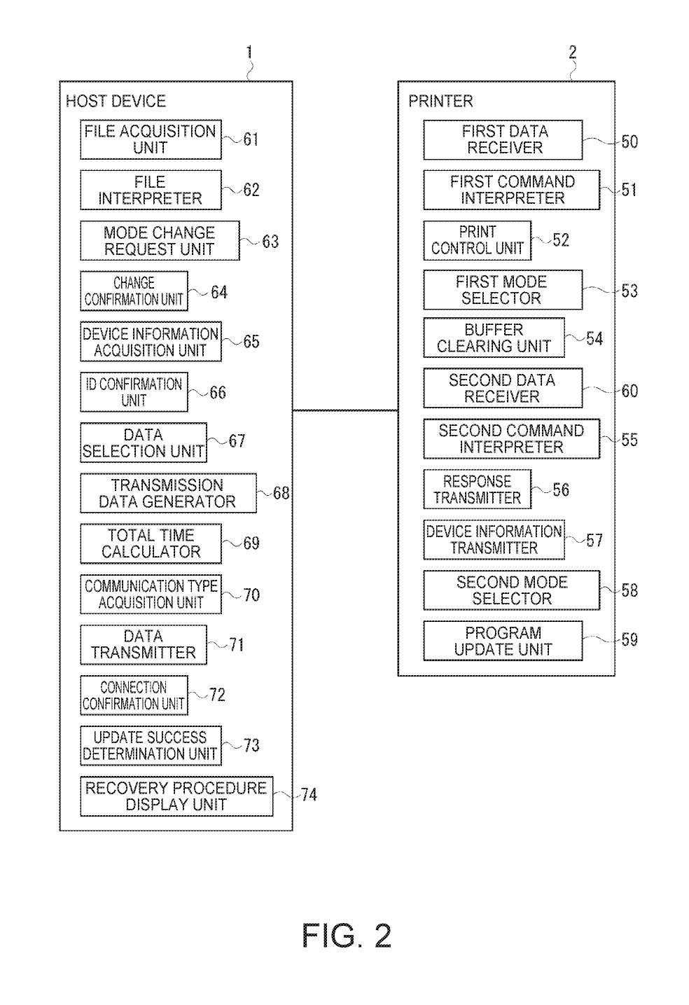

The functional configuration of the host device 1 and printer 2 are described next with reference to FIG. 2. The functional configuration of the printer 2 is described first. As shown in FIG. 2, the printer 2 has a first data receiver 50, first command interpreter 51, print control unit (print controller) 52, first mode selector 53, buffer clearing unit (buffer clearer) 54, second data receiver 60, second command interpreter 55, response transmitter 56, device information transmitter 57, second mode selector 58, and program update unit (program updater) 59.

The first data receiver 50, first command interpreter 51, print control unit 52, and first mode selector 53 are embodied by the control unit 31 running the device control program 36.

The buffer clearing unit 54, second data receiver 60, second command interpreter 55, response transmitter 56, device information transmitter 57, second mode selector 58, and program update unit 59 are embodied by the control unit 31 running the boot program 37.

In the normal control mode, the first data receiver 50 receives data from the host device 1 through the communication interface 21. More specifically, the first data receiver 50 receives print commands and mode selection commands described below through the communication interface 21. The first data receiver 50 is configured to receive real-time commands even if the communication interface 21 is sending a busy signal to the host device 1. In other words, the first data receiver 50 receives real-time commands even when the printer 2 is busy. Because this embodiment of the invention is configured to use a mode selection command, which is a real-time command, a mode selection command (a change-mode request) can be received even when busy (even when the communication interface 21 is sending a busy signal to the host device 1).

In the normal control mode, the first command interpreter 51 applies command interpretation to the received data. More specifically, the first command interpreter 51 determines what kind of (what) command was received in the received data. The first command interpreter 51 also determines if the received data is a normal command or a real-time command.

The print control unit 52 executes a printing process based on the print commands if the result of command interpretation by the first command interpreter 51 is that the received data is a print command. More specifically, the print control unit 52 controls the printer engine 22 and executes the printing process on the print medium based on the print commands.

Based on the change-mode request from the host device 1 in the normal control mode, the first mode selector 53 changes the operating mode of the printer 2 from the normal control mode to the boot control mode. More specifically, the first mode selector 53 receives a mode selection command sent from the host device 1, and change the operating mode of the printer 2 to the boot control mode. The boot control mode includes an information response mode for receiving a request from the host device 1 and returning a response, and an unconditional rewrite mode that executes an update process (rewrite process) based on data from the host device 1, and the first mode selector 53 changes the operating mode to the information response mode or the unconditional rewrite mode according to the mode selection command from the host device 1. Because the host device 1 in this embodiment of the invention is configured to transmit a mode selection command for switching to the information response mode, the first mode selector 53 receives the mode selection command and changes the operating mode of the printer 2 from the normal control mode to the information response mode.

When a mode selection command (change-mode request) for switching to the information response mode is received from the host device 1, the buffer clearing unit 54 erases any data in the communication buffer 46. More specifically, this embodiment of the invention is configured to delete data in the communication buffer 46 by means of the buffer clearing unit 54 after switching the operating mode of the printer 2 to the information response mode.

In the boot control mode, the second data receiver 60 receives data from the host device 1 through the communication interface 21. More specifically, the second data receiver 60 receives response request commands, information request commands, mode selection command, and transmitted data (all described below) through the communication interface 21. The second data receiver 60 is configured to receive real-time command even while the communication interface 21 is reporting a busy state to the host device 1. More specifically, the second data receiver 60 receives real-time commands even when busy. Because this embodiment of the invention is configured to use information request commands communicated as real-time commands, information request commands (information requests) can be received even while busy (when a busy state is reported).

The second command interpreter 55 applies command interpretation to the received data in the boot control mode, and determines what type of real-time command the received data is. More specifically, in this embodiment of the invention, because the host device 1 is configured to transmit commands to the printer 2 as real-time commands when the printer 2 is in the boot control mode, command interpretation can be applied to the received data by determining what real-time command the received data is.

The response transmitter 56 receives a response request command (response request) from the host device 1 in the boot control mode, and sends response confirmation information through the communication interface 21 to the host device 1. The response confirmation information is information indicating if the printer 2 changed to the information response mode of the boot control mode. More specifically, if the printer 2 changed to the information response mode, the response transmitter 56 sends response confirmation information indicating the information response mode was enabled, and sends response confirmation information indicating that the printer 2 is not in the information response mode if the printer 2 has not changed to the information response mode.

Based on the information request command (information request) from the host device 1 in the information response mode, the device information transmitter 57 sends device information for the printer 2 through the communication interface 21 to the host device 1. The device information transmitter 57 sends device information including the printer ID of the printer 2, the configuration of modules in the printer 2, and version information for the firmware of each included module, to the host device 1.

In the boot control mode, the second mode selector 58 switches the operating mode of the printer 2 between the information response mode and the unconditional rewrite mode based on the change-mode request from the host device 1. More specifically, the second mode selector 58 receives the mode selection command sent from the host device 1 and change the mode of the printer 2. More specifically, the second mode selector 58 receives a mode selection command for switching to the unconditional rewrite mode when in the information response mode, and changes the mode of the printer 2 from the information response mode to the unconditional rewrite mode. In the unconditional rewrite mode, the second mode selector 58 receives a mode selection command for changing to the information response mode, and changes the mode of the printer 2 from the unconditional rewrite mode to the information response mode.

In the unconditional rewrite mode, the program update unit 59 updates the device control program 36 based on the transmission data (described below) from the host device 1. More specifically, the program update unit 59 overwrites the firmware and configuration settings for each module in the device control program 36 stored in the storage unit 32 with the data contained in the transmitted data. As a result, the device control program 36 is updated. In other words, the program update unit 59 updates the device control program 36 of the storage unit 32 to the update data by running the boot program 37.

The functional configuration of the host device 1 is described next. The host device 1 has a file acquisition unit (file acquirer) 61, a file interpreter 62, a mode change request unit (mode change requester) 63, a change confirmation unit (change confirmer) 64, a device information acquisition unit (device information acquirer) 65, an ID confirmation unit (ID confirmer) 66, a data selection unit (data selector) 67, a transmission data generator 68, a total time calculator 69, a communication type acquisition unit (communication type acquirer) 70, a data transmitter 71, a connection confirmation unit (connection confirmer) 72, an update success determination unit (update success determiner) 73, and a recovery procedure display unit (recovery procedure display) 74. These components are embodied by the controller 7 running the update manager tool 17.

The file acquisition unit 61 acquires the update data file for applying the update process to the printer 2. An update data file is prepared by the device manufacturer for each model of printer 2, and the content covers each variation of that single model. The file acquisition unit 61 acquires the update data file by downloading the update data file through the Internet or other network from a server used by the manufacturer, or by reading the update data file from a storage medium storing the update data file.

Stored in the update data file are the printer ID (product ID) identifying the model, and update data for each module that may be included in that model. So that the update data covers every variation (sub-model) of a single model, update data for each of the plural modules that may selectively be incorporated in a particular model of printer 2 is stored in the update data file.

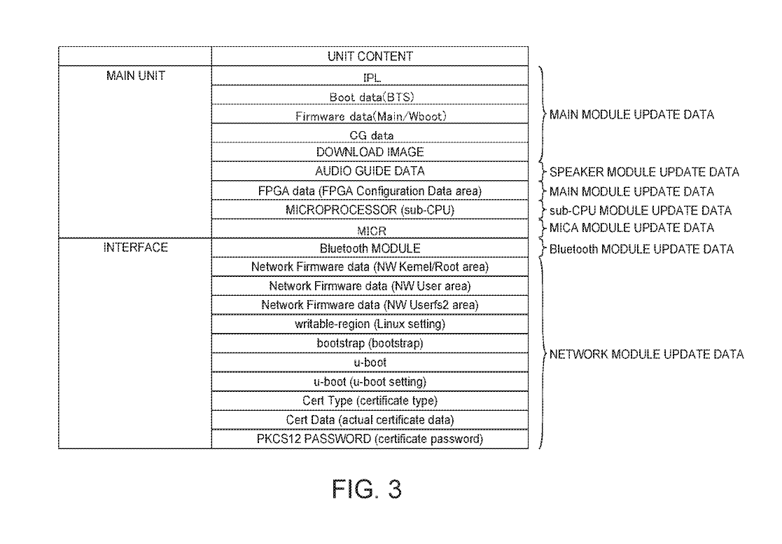

The update data for each module is not stored as a separate object for each module, but instead is stored in more granular “unit” objects. FIG. 3 shows an example of the configuration of a unit (the content of a unit) in the update data file. The units of the update data file shown for example in FIG. 3 include: IPL, Boot date (BTS), Firmware data (Main/Wboot), CG data, a download image, audio guide data, FPGA data (FPGA Configuration Data area), microprocessor (Sub-CPU), MICR (Magnetic ink character recognition), Bluetooth module, Network Firmware (NW Kernel/Root area), Network Firmware (NW User area), Network Firmware (NW Userfs2 area), writable-region (Linux® setting), Bootstrap®, u-boot, u-boot (u-boot setting), Cert type (certificate Type), Cert Data (actual certificate data) and PKCS12 PASSWORD (certificate password).

The IPL, Boot date (BTS), Firmware data (Main/Wboot), CG data, download image, and FPGA data (FPGA Configuration Data area) are update data for the main module. IPL, Boot date (BTS) and Firmware data (Main/Wboot) are firmware of the main module, and CG data, download image, and FPGA data (FPGA Configuration Data area) configuration settings of the main module. Note that the download image is print data that is overprinted on the failed printout when printing fails so that the user knows that printing that printout failed.

The audio guide data is update data for the speaker module. The microprocessor (Sub-CPU) is update data for the sub-CPU module, and is firmware for the sub-CPU. MICR is update data for the MICR module, and is firmware for the MICR module. The Bluetooth module is update data for the Bluetooth module, and is firmware for the Bluetooth module.

Network Firmware (NW Kernel/Root area), Network Firmware (NW User area), Network Firmware (NW Userfs2 area), writable-region (Linux settings), bootstrap, u-boot, u-boot (u-boot settings), Cert type (certificate Type), Cert Data (actual certificate data) and PKCS12 PASSWORD (certificate password) are update data for the network module. Network Firmware (NW Kernel/Root area), Network Firmware (NW User area), Network Firmware (NW Userfs2 area), bootstrap and u-boot are firmware for the network module, and writable-region (Linux settings), u-boot (u-boot settings), Cert type (certificate Type), Cert Data (actual certificate data) and PKCS12 PASSWORD (certificate password) are configuration information for the network module.

In addition to the printer ID and update data for each module, the unit configuration (number and types of units), the update time (rewrite time) required for each unit, and version information for each firmware module, are stored in the update data file.

Referring again to FIG. 2, the file interpreter 62 interprets the acquired update data file, and extracts from the update data file the printer ID, the unit configuration (number and types of units), the update time (rewrite time) required for each unit, and version information for each firmware module. As a result, this information is acquired. The file interpreter 62 acquires the time required to update the update data of each module by acquiring the update time of each unit.

The mode change request unit 63 sends a change-mode request as a real-time command to the printer 2. More specifically, the mode change request unit 63 sends a mode selection command (change-mode request) as a real-time command to the printer 2, and causes the printer 2 to change the operating mode. As described more specifically below, the device control program 36 update operation includes first switching the printer 2 to the information response mode, and after acquiring the device information of the printer 2, switching the printer 2 to the unconditional rewrite mode and controlling the printer 2 to execute the device control program 36 update process. The mode is then again reset to the information response mode, and whether or not the update process was successful is determined. Note that when the printer 2 is set to the boot control mode, commands are sent to the printer 2 as real-time commands.

The change confirmation unit 64 verifies by means of a real-time command if the printer 2 changed to the information response mode. More specifically, the change confirmation unit 64 sends a response request command (response request) as a real-time command to verify whether or not the information response mode was entered, and receives as the response thereto response confirmation information from (the response transmitter 56 of) the printer 2.

The device information acquisition unit 65 acquires the device information of the printer 2 from the printer 2 as a real-time command. More specifically, the device information acquisition unit 65 sends an information request command (information request) as a real-time command, and receives device information as the response to the request from the (device information transmitter 57 of the) printer 2. In other words, the device information acquisition unit 65 acquires the printer ID, module configuration, and version information for each installed module from the printer 2.

The ID confirmation unit 66 compares the printer ID acquired by the device information acquisition unit 65 with the printer ID acquired by the file interpreter 62, and determines if both printer IDs match. In other words, the ID confirmation unit 66 determines if the printer ID to be updated in the update data file matches the printer ID of the printer 2 to be updated.

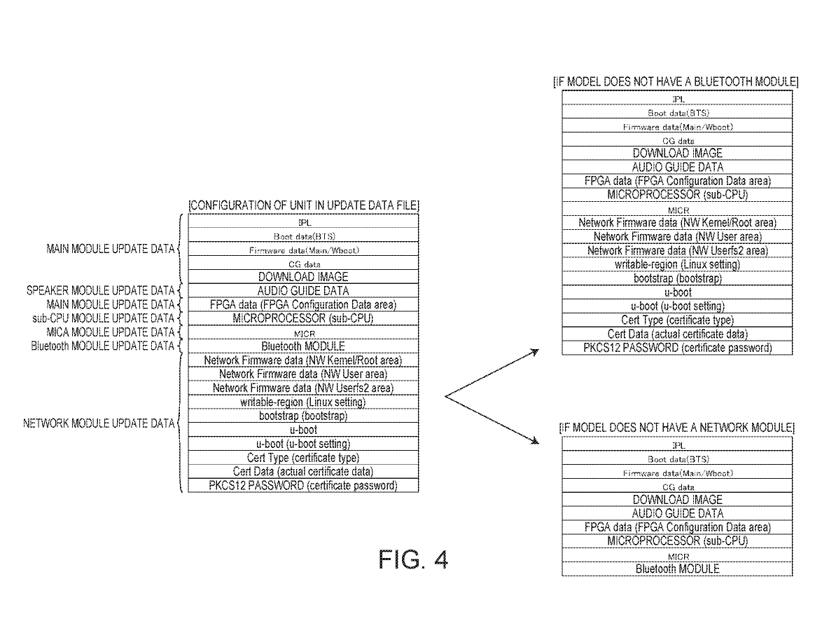

The data selection unit 67 selects the update data (unit) required for the printer 2 from among the update data stored in the update data file. More specifically, based on the module configuration acquired by the device information acquisition unit 65, the data selection unit 67 selects the update data for one or more modules installed to the printer 2 from the update data for all modules stored in the update data file. For example, as shown in FIG. 4, the printer 2 omits the update data for the Bluetooth module if the specific model of printer 2 does not have a Bluetooth module. Likewise, if the printer 2 is a model that does not have a network module, the printer 2 omits the update data for the network module.

The transmission data generator 68 generates transmission data to be sent to the printer 2 based on the selected update data (unit). More specifically, the transmission data generator 68 extracts the selected update data from the update data file, and generates transmission data including the extracted update data.

Based on the update time for each unit acquired by the file interpreter 62, the total time calculator 69 calculates the total update time of the selected update data. More specifically, the total time calculator 69 tabulates the update time for each unit in the selected update data, and calculates the total update time for the selected update data. Note that the total update time is used when confirming the connection after transmitting the transmission data. As a result, the total update time is preferably added to the transmission data.

The communication type acquisition unit 70 acquires the communication method to use for sending the transmission data to the printer 2. More specifically, the communication type acquisition unit 70 determines if the type of communication is USB, Ethernet®, or Bluetooth®. Note that USB stands for Universal Serial Bus.

The data transmitter 71 sends the transmission data generated by the transmission data generator 68 to the printer 2. The data transmitter 71 segments and transmits the transmission data so that the amount of data transmitted in one transmission is sized appropriately to the type of communication acquired by the communication type acquisition unit 70. More specifically, if the data is transmitted by USB or Ethernet, the data is packetized so that the amount of data transmitted in one burst is 2 MB. If transmission is by Bluetooth, the data is packetized so that the amount of data transmitted in one burst is 512 KB.

In this embodiment of the invention, the printer 2 is controlled to execute the update process of the device control program 36 based on the transmission data by the mode change request unit 63 first setting the printer 2 to the unconditional rewrite mode, and the data transmitter 71 then sending the transmission data. If switching to the information response mode by the change confirmation unit 64 is not confirmed, the module configuration cannot be acquired from the printer 2, the data selection unit 67 cannot execute the selection process, and the transmission data generator 68 cannot execute the transmission data generating process. As a result, the update data (all units) for each module is extracted from the update data file and transmitted as the transmission data instead of the data for data transmission generated by the transmission data generator 68. In this event, the extracted update data is converted to a .mot format, the address (sector) for writing (overwriting) the update data in the storage unit 32 of the printer 2 is added and also sent to the printer 2. The .mot format is a data format conforming to the storage unit 32. For example, the .mot format is a sector unit data format for flash ROM devices, and is the format used for writing directly to the storage unit 32.

The connection confirmation unit 72 checks the connection to the printer 2 after the data transmitter 71 sends the transmission data, and determines if the printer 2 completed the update process normally. More specifically, the host device 1 cannot connect to the printer 2 while the printer 2 is executing the update process, and the host device 1 can connect to the printer 2 when the update process ends. Whether or not the update process ended normally can therefore be determined by checking the connection to the printer 2.

More specifically, the connection confirmation unit 72 polls the printer 2 to check the connection until the total update time calculated by the total time calculator 69 has past after transmitting the transmission data. In other words, until the total update time calculated by the total time calculator 69 has past after transmitting the transmission data, the connection confirmation unit 72 repeatedly checks the connection to the printer 2 at a regular interval (such as every several seconds). As a result, the connection confirmation unit 72 determines if the update process was successfully completed by the printer 2.

The update success determination unit 73 determines if the update process of the printer 2 executes normally. In this embodiment of the invention, the update success determination unit 73 compares the version information of the update data file with the firmware of each module, and by determining if the version information for the module in the update data file matches the current version of the corresponding module, determines if the update process was successfully completed by the printer 2. Note that the version information after the update process executes is the version information acquired by the device information acquisition unit 65 after the update process, and the version information of the update data file is the version information acquired by the file interpreter 62.

The recovery procedure display unit 74 presents the recovery procedure on the display 8 if the update success determination unit 73 determines the update process was not completely normally by the printer 2. For example, a message such as “please try updating the device control program again” may be presented on the display 8 to prompt the user to repeat the update operation.

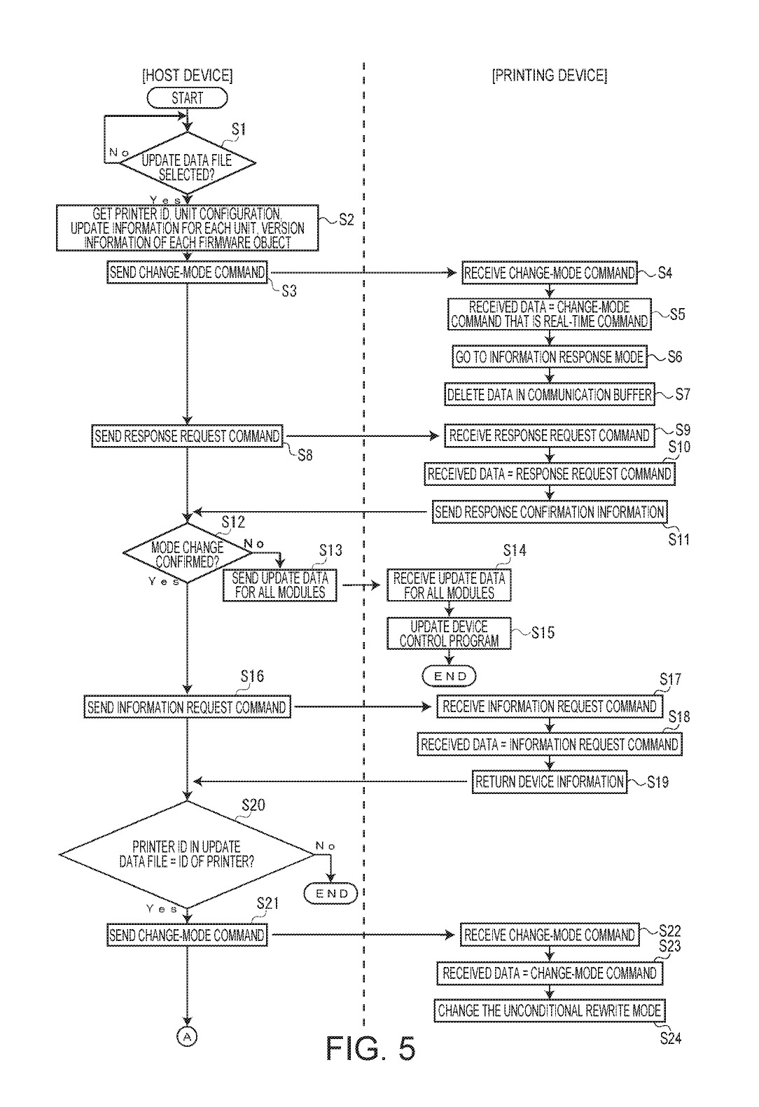

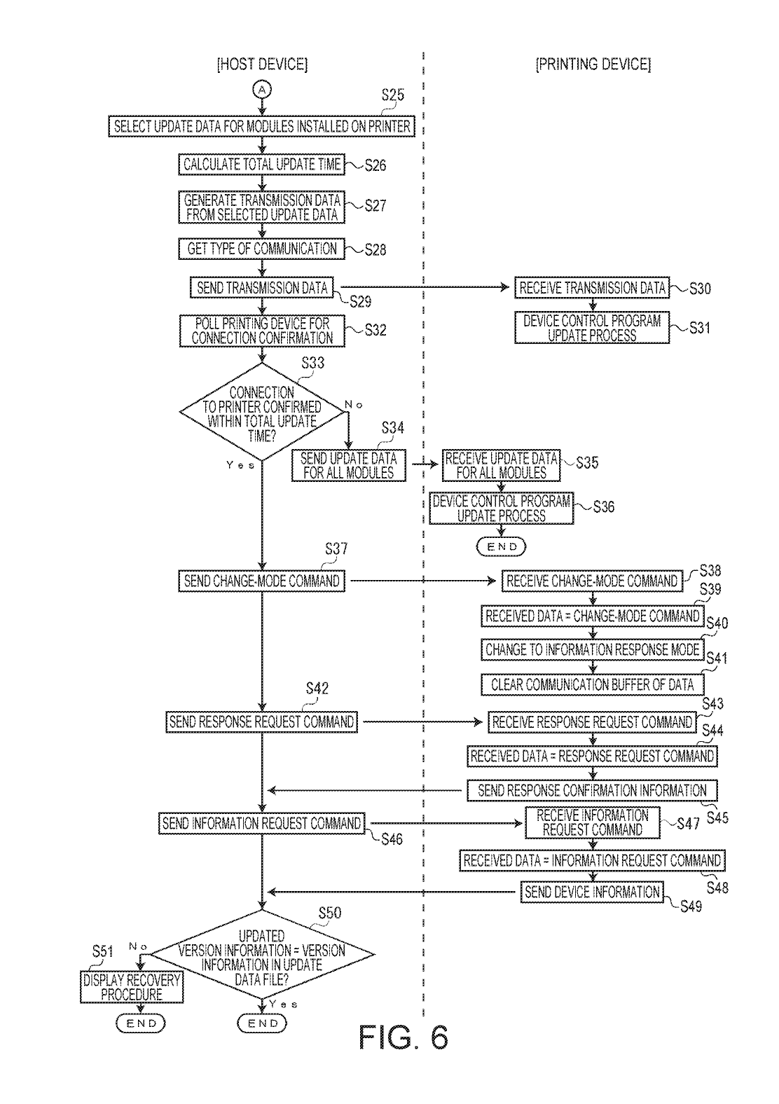

The operation whereby the printing system SY updates the device control program 36 is described next with reference to FIG. 5 and FIG. 6. This update operation executes when the device control program 36 and boot program 37 are stored in the storage unit 32 of the printer 2, the update data file has been acquired by the file acquisition unit 61 of the host device 1, and the update data file on the host device 1 is then specified by the user.

As shown in FIG. 5 and FIG. 6, when the update data file is specified by a user operation (S1: YES), the file interpreter 62 acquires the printer ID, unit configuration (number and types of units), the update time of each unit, and the version of the firmware from the specified update data file (S2).

Once this information is acquired, the mode change request unit 63 sends a change-mode request as a real-time command instructing the printer 2 to switch to the information response mode. More specifically, the mode change request unit 63 sends a mode selection command instructing changing to the information response mode as a real-time command to the printer 2 (S3). The first data receiver 50 of the printer 2 therefore receives the mode selection command (change-mode request) from the host device 1 through the communication interface 21 (S4) (receive change-mode request step), and the first command interpreter 51 interprets the received mode selection command and determines the received data is both a mode selection command and a real-time command (S5). The first mode selector 53 then changes the mode of the printer 2 from the normal control mode to the information response mode based on the received mode selection command (S6) (mode selection step). Next, the buffer clearing unit 54 clears the data in the communication buffer 46 (S7) (clear buffer step.

Note that the mode selection command, which is a real-time command, can be received in the receive change-mode request step even if the communication interface 21 has reported a busy state.

The change confirmation unit 64 of the host device 1 then checks if the printer 2 switched to the information response mode by means of a real-time command. In other words, the change confirmation unit 64 sends a response request command as a real-time command to the printer 2 (S8). The second data receiver 60 of the printer 2 then receives the response request command (response request) from the host device 1 through the communication interface 21 (S9) (receive response request step), and the second command interpreter 55 applies command interpretation to the received response request command and determines if the received data is a response request command (S10). The response transmitter 56 receives the response request command and sends (returns) response confirmation information through the communication interface 21 to the host device 1 (S11) (response confirmation information transmission step). The host device 1 receives the response confirmation information, and confirms if the printer 2 is in the information response mode.

If in this confirmation check the change confirmation unit 64 does not confirm that the printer 2 entered the information response mode (S12: NO), the change confirmation unit 64 extracts the update data for all modules (all units) stored in the update data file from the update data file, and sends the extracted update data as the transmission data to the printer 2 (S13). At this time, the change confirmation unit 64 converts the update data to .mot format data, and adds and sends the write address for the update data with the update data. The second data receiver 60 of the printer 2 then receives the transmission data (update data for all modules) from the host device 1 through the communication interface 21 (S14) (receive update data step), and based on the received transmission data, the program update unit 59 runs the device control program 36 update process (S15) (update program step). In other words, the firmware and settings of each module are overwritten at the specified write addresses. This completes the update process.

The change confirmation unit 64 may also not confirm that the printer 2 switched to the information response mode if the printer 2 returns response confirmation information indicating the information response mode (boot control mode) was not enabled. In the receive update data step, the printer 2 is therefore configured to receive .mot format update data transmitted from the host device 1 when the response transmitter 56 sends response confirmation information indicating that the information response mode (boot control mode) was not enabled.

If the change confirmation unit 64 confirms that the printer 2 switched to the information response mode (S12: YES), the device information acquisition unit 65 acquires the device information of the printer 2 from the printer 2 as a real-time command. More specifically, the device information acquisition unit 65 sends an information request command as a real-time command to the printer 2 (S16).

The second data receiver 60 of the printer 2 then receives the information request command (information request) from the host device 1 through the communication interface 21 (S17) (receive information request step), interprets the received data by means of the second command interpreter 55, and determines if the received data is an information request command (S18). The device information transmitter 57 of the printer 2 then sends (returns) device information (printer ID, module configuration, firmware version information) for the printer 2 through the communication interface 21 to the host device 1 (S19) (transmit information step). The host device 1 receives the device information and acquires the device information for the printer 2.

Note that the information request command, which is a real-time command, can be received in the receive information request step even if the communication interface 21 is busy.

Once the printer 2 device information is acquired, the ID confirmation unit 66 of the host device 1 determines if the printer ID in the update data file matches the printer ID of the printer 2 (S20). More specifically, the ID confirmation unit 66 compares the printer ID acquired by the file interpreter 62 with the printer ID acquired by the device information acquisition unit 65, and determines if both printer IDs are the same. If the printer IDs do not match (S20: NO), an error results and this operation ends.

If the printer IDs match (S20: YES), the mode change request unit 63 sends a change-mode request as a real-time command instructing the printer 2 to switch to the unconditional rewrite mode. More specifically, the mode change request unit 63 sends to the printer 2 a mode selection command as a real-time command instructing the printer to enter the unconditional rewrite mode (S21). The second data receiver 60 of the printer 2 receives the mode selection command from the host device 1 through the communication interface 21 (S22), and the second command interpreter 55 applies command interpretation to the received data and determines if the received data is a mode selection command (S23). The second mode selector 58 then changes the mode of the printer 2 from the information response mode to the unconditional rewrite mode based on the mode selection command (S24).

Based on the module configuration acquired by the device information acquisition unit 65, the data selection unit 67 selects the update data for one or more modules in the printer 2 from the update data of all available modules stored in the update data file (S25). Once the update data is selected, the total time calculator 69 calculates the total update time for the selected update data (S26). Next, the transmission data generator 68 generates the transmission data based on the selected update data (S27).

Once the transmission data is generated, the communication type acquisition unit 70 acquires the communication method to use for sending the transmission data to the printer 2 (S28). The data transmitter 71 then segments the transmission data into transmission blocks of a specific size appropriate to the acquired communication method, and transmits the data (S29).

The second data receiver 60 of the printer 2 then receives the transmission data from the host device 1 (S30) (receive update data step), and the program update unit 59 executes the device control program 36 update process based on the received transmission data (S31) (update program step). More specifically, the firmware and settings in the device control program 36 stored in the storage unit 32 are overwritten with the values stored in the transmission data. In other words, the boot program 37 updates the firmware and settings of the device control program 36 in the storage unit 32 to the update data.

After sending the transmission data, the connection confirmation unit 72 of the host device 1 polls the printer 2 to check the connection (S32). If the total update time calculated by the total time calculator 69 is past but a connection with the printer 2 cannot be confirmed (S33: NO), the printer 2 extracts from the update data file the update data for all modules (all units) stored in the update data file, and sends the extracted update data as the transmission data to the printer 2 in the same way as when switching to the information response mode is not confirmed (S34). The second data receiver 60 of the printer 2 then receives the transmission data (update data for all modules) from the host device 1 through the communication interface 21 (S35), and the program update unit 59 executes the device control program 36 update process based on the received transmission data (S36). As a result, the update process ends.

If a connection to the printer 2 is confirmed before the total update time times out (S33: YES), the mode change request unit 63 sends a change-mode request as a real-time command to change to the information response mode to the printer 2. More specifically, the mode change request unit 63 sends a mode selection command as a real-time command telling the printer 2 to change to the information response mode (S37). The second data receiver 60 of the printer 2 then receives the mode selection command from the host device 1 through the communication interface 21 (S38), and the second command interpreter 55 interprets the received data 2 and determines if the received data is a mode selection command (S39). Based on the mode selection command, the second mode selector 58 changes the mode of the printer 2 from the unconditional rewrite mode to the information response mode (S40). Next, the buffer clearing unit 54 clears the communication buffer 46 of data (S41).

The change confirmation unit 64 of the host device 1 then checks if the printer 2 is in the information response mode by means of a real-time command. More specifically, the change confirmation unit 64 sends a response request command as a real-time command to the printer 2 (S42). The second data receiver 60 of the printer 2 then receives the response request command from the host device 1 through the communication interface 21 (S43), and the second command interpreter 55 interprets the received data and determines the received data is a response request command (S44). The response transmitter 56 receives the response request command and sends (returns) the response confirmation information to the host device 1 through the communication interface 21 (S45). The host device 1 receives the response confirmation information, and confirms whether or not the printer 2 is in the information response mode.

Once the printer 2 is confirmed to be in the information response mode, the device information acquisition unit 65 acquires the device information of the printer 2 from the printer 2 by a real-time command. More specifically, the device information acquisition unit 65 sends an information request command as a real-time command to the printer 2 (S46). The second data receiver 60 of the printer 2 then receives the information request command from the host device 1 through the communication interface 21 (S47), the second command interpreter 55 applies command interpretation to the received data, and determines if the received data is an information request command (S48). The device information transmitter 57 then sends (returns) device information (printer ID, module configuration, firmware version information) for the printer 2 through the communication interface 21 to the host device 1 (S49). The host device 1 receives the device information and acquires the device information for the printer 2.

Once the device information is acquired, the updated version information and the version information of the update data file are compared for each firmware object, and whether or not the version information matches for each firmware object is determined (S50). If the version information matches for all firmware objects (S50: YES), the device control program 36 update process is determined to have completed successfully, and the update process ends. However, if for any firmware object the version information does not match (S50: NO), the recovery procedure display unit 74 presents a recovery procedure on the display 8 (S51), and this update process ends.

Thus comprised, the printer 2 can receive change-mode requests and change to the boot control mode even when the printer 2 is unable to receive normal communications (that is, when the printer 2 is in a busy state, including error states, waiting to be reset from an error, and being unable to print) and reports being busy to the host device 1. The host device 1 can therefore update the device control program 36 even when the printer 2 is busy. The device control program 36 can therefore be updated by the host device 1 even when the printer 2 is busy. For example, if the printer 2 goes to a busy state because, for example, a cover that must be opened to load print media is open (a cover-open state), the paper has run out, or other event preventing printing occurs, the printer 2 can still receive change-mode requests and commands and data required for updating, and the device control program 36 can be updated.

Furthermore, by using a real-time command for the change-mode request, change-mode requests can be processed with priority and immediate updating is possible. For example, change-mode requests are processed with priority over other commands already stored in the communication buffer 46, and updates can be immediately executed.

Furthermore, because data in the communication buffer 46 is deleted (cleared), problems such as data being processed mistakenly in the boot control mode because data is left in the communication buffer 46, and data remaining in the communication buffer 46 being mistakenly stored as part of the update data, can be eliminated. For example, data remaining in the communication buffer 46 being sent to the host device 1 instead of the data that is actually required can be avoided. The printer 2 can also be triggered to automatically delete data in the communication buffer 46 by receiving a change-mode request from the host device 1. As a result, there is no need for the host device 1 to send a command to delete data in the communication buffer 46, and processing can be simplified.

The printer 2 can also simplify command interpretation in the boot control mode because only real-time commands are processed in the boot control mode and normal commands are not. The boot program 37 can therefore be simplified, and the amount of space required in the storage unit 32 can be reduced. Processing in the boot control mode can also be simplified.

Yet further, because the host device 1 generates and sends update data to the printer 2 based on the acquired device information of the printer 2, the printer 2 can receive and update update data appropriate to the printer 2.

When response confirmation information indicating that the information response mode (boot control mode) was not enabled is sent from the printer 2, and the host device 1 cannot acquire the device information for the printer 2, the update process being cancelled can be avoided by changing the data format and sending the update data.

In the embodiment described above, the update success determination unit 73 (update success decision step (S40)) compares the version information to determine if the update process was successful, but whether or not the update process was successful may be determined using a checksum. More specifically, after the update process of the printer 2 ends, checksum information is acquired from the printer 2, and whether or not the update process was successful is determined based thereon.

The device information acquisition unit 65 in the foregoing embodiment is configured to acquire the printer ID, the module configuration of the printer, and version information for the firmware of those modules, but may also be configured to acquire other information about the printer 2, including the interfaces, local fonts, printhead resolution, paper width, and other specifications.

A CPU can achieve the described units by executing a program in a memory or a storage. A circuit (including an ASIC or a FPGA) can achieve the described units. The combination of any of these can achieve the described units.

The disclosure being thus described, it will be obvious that it may be varied in many ways. Such variations are not to be regarded as a departure from the spirit and scope of the invention, and all such modifications as would be obvious to one skilled in the art are included within the scope of the following claims.

What is claimed is:

1. A control method of a printing device capable of communicating with a management device, the control method comprising steps of:
storing a control program configured to control printing, and a boot program configured to update the control program; and
even when a busy state is reported to the management device,
receiving a change-mode request from the management device, and
changing from a normal control mode configured to execute the control program to a boot control mode configured to execute the boot program, based on the change-mode request.

2. The control method of a printing device described in claim 1, further comprising:
in the boot control mode,
receiving update data even when a busy state is reported to the management device, and
updating the control program to the update data by the boot program.

3. The control method of a printing device described in claim 1, wherein:
the busy state is reported to the management device when an error occurs, when waiting for recovery from an error, and when printing is not possible.

4. The control method of a printing device described in claim 1, further comprising:
changing from the normal control mode to the boot control mode with priority over other processes when the change-mode request is received.

5. The control method of a printing device described in claim 1, wherein:
the printing device has a receive buffer configured to store data received from the management device; and
when the change-mode request is received, clears data in the receive buffer.

6. The control method of a printing device described in claim 1, wherein:
normal commands that are processed in the order received, and real-time commands that are processed with priority over normal commands, can be executed in the normal control mode; and
the real-time commands can be executed in the boot control mode.

7. The control method of a printing device described in claim 1, further comprising:
receiving an information request requesting information of the printing device from the management device even when a busy state is reported to the management device; and
sending the information of the printing device to the management device based on the information request.

8. The control method of a printing device described in claim 1, further comprising:
receiving a response request for confirming whether or not the boot control mode was enabled from the management device;
sending response confirmation information indicating whether or not the boot control mode was enabled; and
if response confirmation information indicating the boot control mode was not enabled is sent,
receiving update data in a specific defined data format from the management device, and
updating the control program to the update data.

9. A printing device comprising:
a storage configured to store a control program configured to control printing, and a boot program configured to update the control program;
a communicator configured to communicate with a management device; and
a controller configured to execute the control program and the boot program;
wherein the communicator receives a change-mode request from the management device even when a busy state is reported to the management device; and
the controller changes from a normal control mode configured to execute the control program to a boot control mode configured to execute the boot program, based on the change-mode request.

10. The printing device described in claim 9, wherein:
in the boot control mode, the communicator receives update data even when a busy state is reported to the management device; and
the controller updates the control program to the update data by the boot program.

11. The printing device described in claim 9, wherein:
the communicator reports a busy state to the management device when an error occurs, when waiting for recovery from an error, and when printing is not possible.

12. The printing device described in claim 9, wherein:
the controller executes a change-mode request with priority over other processes.

13. The printing device described in claim 9, further comprising:
a receive buffer configured to store data received from the management device; and
when the communicator receives the change-mode request, the controller clears the receive buffer of data.

14. The printing device described in claim 9, wherein:
the controller processes normal commands that are processed in the order received, and real-time commands that are processed with priority over normal commands, in the normal control mode; and
can execute real-time commands in the boot control mode.

15. The printing device described in claim 9, wherein:
the communicator receives an information request requesting information of the printing device from the management device even when a busy state is reported to the management device, and
sends the information of the printing device to the management device based on the information request.

16. The printing device described in claim 9, wherein:
the communicator receives a response request for confirming whether or not the boot control mode was enabled from the management device,
sends response confirmation information indicating whether or not the boot control mode was enabled, and
if response confirmation information indicating the boot control mode was not enabled is sent,
receives update data in a defined data format from the management device; and
the controller updates the control program to the update data.

17. A storage medium storing a program executed by a controller configured to control parts of a printing device that can communicate with a management device, the program comprising steps causing the controller to:
receive a change-mode request from the management device even when a busy state is reported to the management device; and
based on the change-mode request, change from a normal control mode configured to execute a control program that controls printing to a boot control mode configured to execute a boot program that updates the control program.
